(19) United States
(12) Patent Application Publication
(10) Pub. No.: US 2025/0013713 A1
(43) Pub. Date: Jan. 9, 2025

(54) METHOD FOR DETERMINING SPATIAL COORDINATES OF A SOURCE CAUSING A DISPERSION EFFECT

(71) Applicants: COMMISSARIAT A L’ENERGIE ATOMIQUE ET AUX ENERGIES ALTERNATIVES, PARIS (FR); UNIVERSITE GRENOBLE ALPES, SAINT-MARTIN-D’HERES (FR); Centre National de la Recherche Scientifique, Paris (FR); Institut Polytechnique de Grenoble, Grenoble Cedex (FR)

(72) Inventors: Roman LOPEZ-FERBER, GRENOBLE (FR); Sylvain LEIRENS, GRENOBLE (FR); Didier GEORGES, GRENOBLE (FR)

(21) Appl. No.: 18/762,032

(22) Filed: Jul. 2, 2024

(30) Foreign Application Priority Data
Jul. 7, 2023 (FR) 2307321

(51) Int. Cl. G06F 17/13

(52) U.S. Cl. CPC G06F 17/13

(57) ABSTRACT

A method for determining spatial coordinates of a source causing a dispersion effect in a domain, the dispersion effect being approximated by a system of partial differential equations, the method including computer-implemented steps, of obtaining measurements each quantifying at a point in space in the domain and at a given time a state variable modeled by the system of partial differential equations at the point and at the time, and of iteratively minimizing differences between the measurements and the computations of the system of equations to locate a position of the source. The system of equations is expressed in terms of finite differences generated by radial basis functions, the system of equations being solved in a least-squares context, using a least-squares solver, the system of equations having been subject to adjoint quadratic solution with radial basis functions chosen from polyharmonic-spline functions, inverse-multiquadric functions, or Gaussian functions.

### CROSS-REFERENCE TO RELATED APPLICATION

This application claims priority to foreign French patent application No. FR 2307321, filed on Jul. 7, 2023, the disclosure of which is incorporated by reference in its entirety.

### FIELD OF THE INVENTION

The invention relates to the field of modeling the dispersion of air pollution, in particular in an urban environment.

### BACKGROUND

It would be advantageous to be able to identify (locate and estimate the shape and amplitude of) sources of air pollution in urban areas, and in particular in the urban canopy, based on a set of localized measurements.

Thus, the problem addressed is that of identifying sources of pollution in urban areas by means of a network of low-cost sensors. Such sources emit pollutants (gases, particles) that are dispersed by the wind. The complex geometry of urban buildings generates a wind field that is non-uniform on a district scale.

Given a choice of model and a set of noisy measurements (sensor network or mobile sensors), it is a question of solving an inverse problem to estimate the position and characteristics of the sources. The problem is one of robust fusion of spatio-temporal data in the presence of spatial constraints and measurement uncertainties.

Known reliable methods are methods based on physical models in which one or more unknown input terms applied to partial differential equations (PDEs) are sought by minimizing the error between the measurements and the output of a mathematical model representing the physical system, said model therefore being sensitive to unknown inputs that must be estimated.

As regards identification of sources of pollution, a number of methods have been applied in the prior art, such as Kalman filtering and its variants (Defforge, 2019; Mons et al., 2017), the calculus of variations (Kumar et al., 2015) sometimes associated with the use of reduced models (Khodayi-mehr, 2019) or even particle filters (Septier et al., 2020).

These methods have the drawback of being computationally expensive, or, in the context of use of computationally less expensive reduced models, of requiring a training database to be created for each dispersion scenario.

In addition, air pollution is a three-dimensional phenomenon that to be modeled requires fine and complex computational spaces.

### A Specific Tool: Least-Squares Radial-Basis-Function Finite Differences

The source-term estimation approach employed in the present invention uses an LS-RBF-FD approach (LS-RBF-FD standing for Least-Squares Radial-Basis-Function Finite Differences) to create an accurate numerical model of pollutant dispersion. Modelling based on LS-RBF-FD has recently been described in the literature (Tominec et al., 2021). Similar to the RBF-FD approach, which has been known for about 10 years (Flyer et al., 2012), LS-RBF-FD shares the rapidity of RBF-FD but displays greater robustness in the computation of solutions, in particular when it is a question of computing three-dimensional field variables.

### Modelling of Air Pollution

The LS-RBF-FD approach is used in one embodiment on a pollutant-transport equation called the advection-diffusion equation and denoted ADPDE. This equation models transport of pollutants considered not to react and governs a scalar concentration field u: x∈Ω=Ω°∪∂Ω, t∈T [symbol] u(x, t). This equation is written

$$\{ \begin{matrix}\frac{\partial u}{\partial t} + {U}_{x} \frac{\partial u}{\partial x} + {U}_{y} \frac{\partial u}{\partial y} + {U}_{z} \frac{\partial u}{\partial z} = & x ∈ Ω° \\ \frac{\partial }{\partial x} ( {K}_{x} \frac{\partial }{\partial x} ) + \frac{\partial }{\partial y} ( {K}_{y} \frac{\partial u}{\partial y} ) + \frac{\partial }{\partial z} ( {K}_{z} \frac{\partial U}{\partial z} ) + s , & \\ {\partial }_{i} u \cdot \overline{n} = 0 & x ∈ {Γ}_{N} \\ u ( x , t ) = 0 & x ∈ {Γ}_{D} \\ u ( x , t = 0 ) = {u}_{0} & x ∈ Ω°\end{matrix} \qquad [ Eq . 1 ]$$

with t∈T time, x∈Ω⊂ [symbol] ³ position, Uᵢ, Kᵢ the components of the velocities and diffusivities of the mean wind and diffusion fields, u pollutant concentration, s a pollution source term.

Ω represents the spatial domain where the advection-diffusion differential equation is applied while ∂Ω=Γ_{D}∪Γ_{N} represents the edges of the domain where boundary conditions are applied. The situation of interest is one where Γ_{D} is the edge domain where Dirichlet conditions apply and Γ_{N} the edge domain where no-flux conditions apply.

The weather, namely the wind field U and diffusion field K, is obtained using a third-party model.

Advection/diffusion equations are difficult to model in an urban environment with spatial constraints and are computationally expensive. It is necessary to provide a solution allowing computation to be made accessible.

### Writing the Advection/Diffusion Equation in the Steady State, in the Form of Differential Operators

The ADPDE is solved in a steady state. In addition, the physical model may be reformulated in a condensed manner by expressing the differentiation operators applied to c as a generic differential operator [symbol] in Ω° and [symbol] where the boundary conditions apply, namely ∂Ω=Γ_{D}∪Γ_{N} such that,

$$ℒ c ( x ) = s ( x ) , x ∈ Ω° ; ℬ c ( x ) = g ( x ) , x ∈ {\partial }_{Ω} .$$

In the ADPDE, s is the source term and g=0.

RBFs are known to satisfactorily interpolate spaces (2D, 3D and 4D spaces in particular).

Any function f: y∈Ω [symbol] f(y)∈f(Ω)⊂ [symbol] ^{d} (d being the dimension of the space) can be reconstructed by a number of (RBF) basis functions ϕ centered on nodes {xᵢ}ᵢ₌₁^{N}^{ₓ}=X⊂Ω. If the interpolating function of f is denoted \hat{f} then,

$$\begin{matrix}[ Eq . 2 ] & \\ \hat{f} ( y ) = {\sum }_{i = 1}^{{N}_{x}} {a}_{i} ϕ ( ‖ y - {x}_{i} ‖ ) , ∀ y ∈ Ω . & ( 2 )\end{matrix}$$

where ∥⋅∥ denotes the Euclidean norm. It is known that \hat{f} is a satisfactory approximation of f under condition of regular spacing of the basis centers xᵢ. The interpolation problem then admits a single vector solution of coefficients ā=(a₁, . . . , a_{N}_{ₓ})^{T} for various bases [(Fornberg and Flyer, 2015) Chapter 3, p. 39-47] and in particular for the PHS bases used here (PHS standing for polyharmonic splines) [(Barnett, 2015) p. 13 theorem 2]. The PHS are expressed as follows,

$$ϕ ( y ) = {r}^{2 k - 1} , k \geq 1 , with r = ‖ y - {x}_{i} ‖ . \qquad [ Eq . 3 ]$$

### Inverse Problem in the Sense of Estimation of Source Terms With Partial Differential Equations

Solving the inverse problem is considered equivalent to execution of the workflow with methods based on models.

A vector of unknowns θ is the variable to be estimated, and is initialized to the value θ₀. For example in the above advection-diffusion equation, Equation (1), θ may correspond to the whole source vector (for example θ=s̅) but also, if the source is unique, θ may correspond to a parameterization expressed with an amplitude and a position (for example θ=(aₛ, xₛ)).

The measurements u^{m} sample the field variable u, for example the concentration field of the advection-diffusion equation. They are generally noisy, and the algorithm implementing the inverse method may be provided with a noise model if the noise of the sensors is characterized.

The physical constraint model (dispersion model) m applies to the unknowns θ input into the model, and hence uₑ=m(θ). Thus, the computed field variable uₑ is of the same nature as u^{m}. A measurement model h is applied to match the measurements u^{m} (in particular their positions) with m(θ) to compute a (generally quadratic) deviation of the type r²=[u^{m}−h(m(θ))]² that allows an error term to be expressed.

Variational or Bayesian methods optimize this error term to return an estimate \hat{θ}, optionally with ranges of uncertainties. Estimation generally requires the physical model m to be called upon several times, this being computationally expensive.

The result of the workflow is estimated parameters and an uncertainty if the method is Bayesian.

The inverse problem addressed is reconstruction of the discretized source term s̅. Identification of a source term, irrespectively of whether it is parameterized or not, is referred to as estimation of the source term.

Radial basis functions, their finite-difference variants and their least-squares finite-difference variants (LS-RBF-FD) are known. LS-RBF-FD is used here to model air pollution and to solve the inverse problem of pollution-source estimation, in combination with a model reduction.

The article (Khodayi-mehr, 2019) uses reduced models for source identification. The model reduction is obtained by principal component analysis (PCA). To construct these models, the authors created several steady-state dispersion scenarios by varying only the position of a pollution source. To solve their inverse problem, they used an adjoint variational method that makes multiple calls to the reduced model trained by PCA on two cases of steady-state two-dimensional studies. However, heightwise transport is non-negligible. It is thus preferable to use three-dimensional transport models. In addition, PCA requires training data. If the physical domain changes or if the weather or the shape of the pollutant sources changes, a new database needs to be built.

The article (Liu et al., 2019) addresses modeling air pollution using RBF-FD not solved either three-dimensionally or by least squares. The authors use a two-dimensional RBF-FD non-steady-state physical model of pollutant transport. They computed the weather and reused the mesh as computation points in their model. The computational domain contains obstacles of rectangular shape. A complex urban geometry would require the inner courtyards of buildings to be handled, which it would be necessary to close beforehand as not doing so would run the risk of generating model indeterminacy. In addition, heightwise transport plays a non-negligible role in dispersion.

The article (Tominec et al., 2021) uses the LS-RBF-FD technique. The LS-RBF-FD method is a generalization of RBF-FD. It is based on two sets of computation points X and Y of Nₓ and N_{y} points.

Y is anchored by physics and contains the boundary-condition constraints of the geometric shapes. X is less dense than Y and covers the physical domain without needing to be confined by the edges of the domain (X may have points beyond the domain, or even solely inside the domain). Thus, as with RBF-FD, it is possible to construct a differentiation matrix D that discreetly models by RBF-FD the operators [symbol] and [symbol] defined inside Ω, Ω° and its edges ∂Ω so that the solution of the system comparable to (2) may be expressed by:

$${\overline{u}}_{a} = arg m {i}_{\overline{v}} n {‖ D \overline{v} - \overline{f} ‖}^{2} ,$$

with ūₐ∈ [symbol] ^{N}^{ₓ}, and D an N_{y}×Nₓ differentiation matrix with,

$$D ( {y}_{k} ) = \{ \begin{matrix}L ( {y}_{k} ) & if {y}_{k} ∈ Ω° \\ B ( {y}_{k} ) & if {y}_{k} ∈ \partial Ω\end{matrix}$$

$$\overline{f} == \{ \begin{matrix}s ( {y}_{k} ) & if {y}_{k} ∈ Ω° \\ 0 & if {y}_{k} ∈ \partial Ω\end{matrix}$$

where L and B are the differentiation matrices obtained by RBF-FD for spatial operators [symbol] and [symbol] , and yₖ∈Y={yₖ}ₖ₌₁^{N}^{_{y}} a point of Y.

The article (Tominec et al., 2021) uses uniform-diffusion equations with hybrid (Dirichlet, Neumann) boundary conditions. No three-dimensional solution is disclosed or discussed. Modelling of air pollution is not mentioned. Inverse problems are not addressed.

The principle of RBF and in particular RBF-FD is presented, inter alia, in (Barnett, 2015) p. 2-13.

### Creation of PDE Models Generated by RBF

RBFs have spatial interpolation properties. Let a finite set Y⊂Ω that partitions Ω and allows the variations of y in Equation (3) to be represented by yⱼ∈Y={yⱼ}ⱼ₌₁^{N}^{_{y}}. the elements of Y be considered, and in addition let two sets of computational nodes defined in the interior of the domain Ω° and on its edge ∂Ω be considered, the first set being a set X of nodes covering Ω, with Nₓ=card(X)— these nodes are used below as RBF centers to make local interpolation approximations in the manner of Equation (2). The nodes are distributed using an energy minimization algorithm that employs a pseudo-random Halton sequence to satisfactorily cover the spatial domain.

A set Y of evaluation nodes made up of two subsets of nodes Y_{Ω°} and Y_{∂Ω} corresponding to nodes inside the domain, i.e. in Y_{Ω°}, and those present on the edge, Y_{∂Ω}, respectively. Y is generated in a manner similar to X. The following notion is used: N_{y}_{_{Ω°}}=card(Y_{Ω°}) and N_{y}_{_{∂Ω}}=card(Y_{∂Ω}), with N_{y}=card(Y)=N_{y}_{_{Ω°}}+N_{y}_{_{∂Ω°}}.

### Methods Based on RBF-FD

The idea in this method is to approximate the constraints imposed on a variable u governed by a partial differential equation at a point in space y=yₖ∈Y. Basis centers/PDE points (X) neighboring the evaluation point are used to express these constraints. This set of neighboring points in X form a set of points centered on yₓ∈Y. This set is called S_{y}_{ₖ}⊂X and referred to as a stencil. Let x^{y}^{ₖ}∈S_{y}_{ₖ}, it is then possible to locally interpolate a variable u∈Ω such that ∀x^{y}^{ₖ}∈S_{y}_{ₖ}⊂X,

$${u}_{a} ( {x}^{{y}_{k}} ) = {\sum }_{i = 1}^{n} {w}_{i} ϕ ( ‖ {x}^{{y}_{k}} - {x}_{i} ‖ ) + {\sum }_{i = 1}^{m} {λ}_{i} {p}_{i} ( {x}^{{y}_{k}} ) .$$

In the above equation, wᵢ and λᵢ are weighting coefficients of the approximation and the pᵢ are monomials used to regularize the approximation to impose Σᵢ₌₁ⁿwᵢpⱼ(xᵢ)=0 ∀j∈{1, . . . , m}. The local interpolating function of u is denoted uₐ. The vector of the uₐ(xᵢ^{y}^{ₖ}) is denoted u̅ₐ̅(yₖ) for all xᵢ^{y}^{ₖ}∈S_{y}_{ₖ}. The local interpolation (7) may be vectorized such that,

$${\underbrace{( \begin{matrix}Φ ( {y}_{k} ) & P \\ {P}^{T} & 0\end{matrix} )}}_{A ( {y}_{k} )} ( \begin{matrix}\overline{w} \\ \overline{λ}\end{matrix} ) = ( \begin{matrix}\overline{{u}_{a}} ( {y}_{k} ) \\ \overline{0}\end{matrix} ) , \qquad [ Eq . 8 ]$$

where Φ is the RBF collocation matrix of the stencil S_{y}_{ₖ} such that ∀xⱼ∈{xⱼ}ᵢ₌₁ⁿ=S_{y}_{ₖ},

$$Φ ( {y}_{k} ) = [ \begin{matrix}ϕ ( ‖ {x}_{1} - {x}_{1} ‖ ) & … & ϕ ( ‖ {x}_{n} - {x}_{1} ‖ ) \\ ⋮ & ⋱ & ⋮ \\ ϕ ( ‖ {x}_{n} - {x}_{n} ‖ ) & … & ϕ ( ‖ {x}_{n} - {x}_{n} ‖ )\end{matrix} ] \qquad [ Eq . 9 ]$$

FIG. 1 One example of a stencil can be seen in FIG. 1. It is composed of X points, centered around yₖ∈Y among other points.

The vectors w̅ and λ̅ are obtained by inverting the matrix A(yₖ),

$$( \begin{matrix}\overline{w} \\ \overline{λ}\end{matrix} ) = {A ( {y}_{k} )}^{- 1} ( \begin{matrix}\overline{{u}_{a}} ( {y}_{k} ) \\ \overline{0}\end{matrix} ) \qquad [ Eq . 10 ]$$

In a similar manner, it is possible to locally interpolate a differential operator [symbol] on u at a point yₖ∈Y such that,

$$ℒ {u}_{a} ( y ) = {\sum }_{i = 1}^{n} {w}_{i} ℒϕ ( ‖ y - {x}_{i} ‖ ) + {\sum }_{i = 1}^{m} {λ}_{i} ℒ {p}_{i} ( y ) \qquad [ Eq . 11 ]$$

Equation 11 can be reformulated in the manner of Equation 8:

$$ℒ {u}_{a} ( {y}_{k} ) = {( ℒΦ )}^{T} ( {y}_{k} ) \overline{w} + {( ℒ P )}^{T} ( {y}_{k} ) \overline{λ} \qquad [ Eq . 12 ]$$

By introducing (10) into (12) the following is obtained,

$$ℒ {u}_{a} ( {y}_{k} ) = [ ( {( ℒΦ )}^{T} ( {y}_{k} ) , {( ℒ P )}^{T} ( {y}_{k} ) ) {A}^{- 1} ] ( \begin{matrix}\overline{{u}_{a}} ( {y}_{k} ) \\ \overline{0}\end{matrix} ) \qquad [ Eq . 13 ]$$

By positing, [Eq. 14] ( [symbol] , [symbol] )=(( [symbol] Φ)(yₖ))^{T}, ( [symbol] P)^{T}(yₖ))A⁻¹, the following is obtained after removing the polynomial terms, which cancel each other out,

$$ℒ {u}_{a} ( {y}_{k} ) = {\overline{w}}^{{ℒ}^{T}} \overline{{u}_{a}} ( {y}_{k} ) \qquad [ Eq . 15 ]$$

The above is equivalent to [symbol] uₐ(yₖ)= [symbol] (uₐ(x₀^{y}^{ₖ}), . . . , uₐ(xₙ^{y}^{ₖ}))^{T}, xᵢ^{y}^{ₖ}∈S_{y}_{ₖ}⊂X

To express the finite differences applied to the operator [symbol] u(y)|_{y=y}_{ₖ}, the weight vectors [symbol] and [symbol] are found by solving the system

$$[ \begin{matrix}Φ & P \\ {P}^{T} & 0\end{matrix} ] [ \begin{matrix}{\overline{w}}^{ℒ} \\ {\overline{λ}}^{ℒ}\end{matrix} ] = [ \begin{matrix}( ℒϕ ) ( y = {y}_{k} ) \\ ( ℒ p ) ( y = {y}_{k} )\end{matrix} ] \qquad [ Eq . 16 ]$$

It is thus possible to approximate each differential operator [symbol] u(yₖ)∀yₖ∈Y as a weighted sum of n neighbouring values of u defined in X. It is possible to perform this approximation on other differential operators such as that [symbol] of the boundary conditions. Thus it is possible to create a discrete differentiation matrix D of N_{y}×Nₓ size that for any yₓ∈Y expresses the differentiation weights that apply to it. The weights are stored row by row such that ∀yₖ∈Y,

$${D}_{k , :} = \{ \begin{matrix}[ 0 , … , {w}_{1}^{ℒ} , … , {w}_{n}^{ℒ} , …0 ] if {y}_{k} ∈ Ω° \\ [ 0 , … , {w}_{1}^{ℬ} , … , {w}_{n}^{ℬ} , …0 ] if {y}_{k} ∈ \partial Ω\end{matrix} \qquad [ Eq . 17 ]$$

Zeroes (0's) are added to the weight vectors of D for nodes of X not forming part of the stencil S_{y}_{ₖ}.

### SUMMARY OF THE INVENTION

The invention pertains to modeling, in particular inverse modeling of urban air pollution, and uses an LS-RBF-FD approach to modelling. LS-RBF-FD is used to express the direct air-pollution model and a least-squares solver is used to obtain the solution, in particular to advection-diffusion transport equations, the RBF-FD method in contrast merely achieving collocation.

The invention achieves model reduction without requiring a training method, through selection of a small X solution space, this allowing computation to be sped up and being useful for inversion.

One advantage of this method is the reduction in the size of the unknown that is the source vector: the problem is thus better stated.

Generally, RBFs make it possible to project the sought variables into spaces of small dimensions.

The invention also consists in an original and effective adjoint quadratic solution. It is effectively implemented on a simple case study.

The invention relates to unprecedented modeling of transport of atmospheric pollutants with the LS-RBF-FD method. This method is fast and has an inherent ability to effect model reduction, this paving the way to discovery of the source.

Thus, in order to improve existing techniques for searching for sources, a method is provided for determining spatial coordinates of a source causing a dispersion effect in a domain, the dispersion effect being approximated by a system of partial differential equations, the method comprising computer-implemented steps,
of obtaining measurements each quantifying at a point in space in the domain and at a given time a state variable modeled by the system of partial differential equations at said point and at said time, and
of iteratively minimizing differences between the measurements and the computations of the system of equations to locate a position of said source.

The domain is typically part of an urban canopy, i.e. a district of a city or a peri-urban area, the atmosphere of which is being modeled, up to about 50 m above the ground, for example. The diffusion source may be a stationary car emitting exhaust gases, for example.

The method is special because the system of equations is expressed in terms of finite differences generated by radial basis functions, the system of equations being solved in a least-squares context, using a least-squares solver, the system of equations having been subject to adjoint quadratic solution with radial basis functions chosen from polyharmonic-spline functions, inverse-multiquadric functions, or Gaussian functions, with regularization polynomials of order 1 or higher.

Advantage is taken of the fact that discretization is oversampled in the LS-RBF-FD method and hence it allows a solution to a least-squares problem.

The invention is based on the distinction between two sets of computation points X, Y, one of which has a cardinal greater than the other by a factor of at least 3.

The method used guarantees digital stability in the processor that conducts the computations.

By virtue of this method based on LS-RBF-FD, it is possible to employ an approximation space (X) that is not very fine, while obtaining quality solutions. This choice allows the size of the unknown (the values of the sought source vector) to be decreased, and the computations to be sped up.

The proposed method cleverly makes use of a constraint relaxation effect, and has more evaluation points than unknowns. What is sought is a source term S̅ that minimizes the deviation from the measurements when the physical model is applied to the source term.

According to advantageous and optional features
the steps of obtaining the localized measurements and of minimizing the differences between the measurements and computations may be carried out in a spatial domain described with Neumann and Dirichlet boundary conditions;
the domain may also be characterized, apart from by its boundaries, by field data in the interior of the domain;
the dispersion effect may be a dispersion of pollutants and said transport may be modeled by an advection-diffusion equation;
the dispersion effect may be diffusion of heat from a hot spot in an energy system;
the dispersion effect may be sound spreading in a complex environment;
the least-squares solver may be of L-BFGS-B or LSQR type;
the polyharmonic-spline function used may be a PHS5, and beyond this specific function polyharmonic-spline functions of order of at least 3, and preferably of odd order, are preferred. Other RBFs may be used, such as inverse-multiquadric functions or Gaussian functions;
the iterative minimization of the differences between the measurements and the computations of the system of equations may be carried out in order also to determine an intensity of said source.

### BRIEF DESCRIPTION OF THE DRAWINGS

The invention will be better understood and other advantages will become apparent on reading the following non-limiting description with reference to the appended figures, in which:

FIG. 1 shows a stencil, or set of neighboring points via which the constraints imposed at said point on a variable governed by a partial differential equation are approximated.

FIG. 2 shows the, fairly dense, set of points in the domain for which the constraints of the boundary conditions and the applicable physical rules are given in the model.

FIG. 3 shows one embodiment of a method according to the invention.

FIG. 4 shows (left-hand part) the results of the method, implemented for a particular case (shown in the right-hand part).

FIG. 5 shows other results for the same particular case.

FIGS. 6 and 7 show other results for the same particular case with prior use of simulated results.

FIG. 8 shows results obtained in the context of an extension of the method.

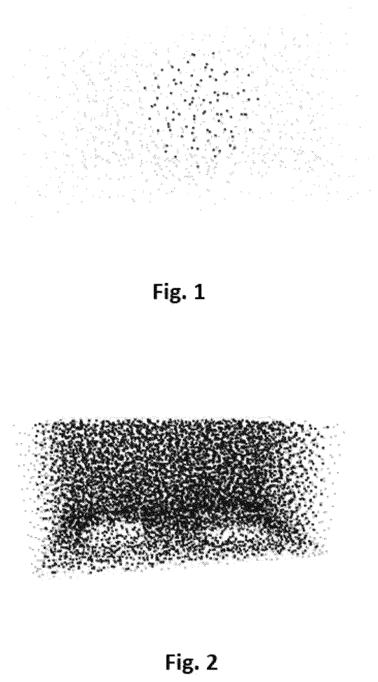

### DETAILED DESCRIPTION

### The Particularity of LS-RBF-FD and Its Advantages

The LS-RBF-FD approach employs two distinct sets of computations such that Y≠X and card(Y)/card(X)≥3. The value of 3 or more is a threshold that has proved reasonable.

The technique then consists in solving a least-squares problem in the case of the presented steady-state ADPDE,

$$\overline{{u}_{a}} = arg m {i}_{\overline{u}} n {‖ D \overline{u} - \overline{f} ‖}^{2} , with , \qquad [ Eq . 18 ]$$

$$( \overline{{u}_{a}} , \overline{u} ) ∈ {ℝ}^{{N}_{x}} \times {ℝ}^{{N}_{x}} , and \overline{f} ∈ {ℝ}^{{N}_{y}}$$

the, agglomerated source term defined in the coordinates of Y comprising the zero Neumann and Dirichlet boundary conditions and the source term such that

$${f}_{k :} = \{ \begin{matrix}s ( {y}_{k} ) if {y}_{k} ∈ {Y}_{Ω°} ⊂ Ω \\ 0 if {y}_{k} ∈ {Y}_{\partial Ω}\end{matrix} \qquad [ Eq . 19 ]$$

The least-squares formulation of Equation 18 has a number of advantages:
it helps to relax equality constraints on the boundary conditions of the type u=d(y) on Γ_{D} and ∇u·n̅=t(y) on Γ_{N} (for the Neumann and Dirichlet conditions, respectively);
the stability of uₕ is increased because the problem of Equation 18 is overdetermined, with more evaluation points in Y than unknowns in X;
the method is robust even in the case of computational meshes of low density;
the differentiation matrix D is very sparse (it contains a lot of 0's) and therefore solution takes little time;
it is possible to choose a solution space X that is very small, 5 times less dense than Y for example, with a view to projecting the model into a space of small dimension particularly suitable for inverse problems.

As a result of the way in which D is defined, with

$$D ( {y}_{k} ) = \{ \begin{matrix}L ( {y}_{k} ) if {y}_{k} ∈ {Y}_{Ω°} ⊂ Ω \\ B ( {y}_{k} ) if {y}_{k} ∈ {Y}_{\partial Ω}\end{matrix} ,$$

it is possible to extract from D two sub-matrices, D_{Ω°} and D_{∂Ω}, that stack the L(yₖ) for all the yₖ∈Y_{Ω°} and B(yₖ) for all the yₖ∈Y_{∂Ω}, respectively.

Equation (18) admits a single solution when D is of full rank with [Eq. 20] u̅ₐ̅=D⁺f̅, with D⁺=(D^{T}D)⁻¹D^{T}, the left pseudo-inverse of D. In practice the problem of Equation 18 is solved by a least-squares solver. L-BFGS-B and LSQR solvers have been tested (LSQR standing for least squares and L-BFGS-B standing for limited-memory BFGS variant-B, BFGS standing for Broyden-Fletcher-Goldfarb-Shanno). The fastest turned out to be the LSQR solver. However, from Equation 20 it is possible to construct an advantageous optimality condition for the inverse problem,

$$E {u}_{a} - {D}_{Ω°}^{T} \overline{s} ( {Y}_{Ω°} ) = 0 , with E = {D}_{Ω°}^{T} {D}_{Ω°} + {D}_{\partial Ω}^{T} {D}_{\partial Ω} . \qquad [ Eq . 21 ]$$

FIG. 2 is a three-dimensional view of a domain Y generated with N_{y}=15000. The interior nodes in Ω°, and the Neumann nodes and Dirichlet nodes may be seen.

Thus, a direct Eulerian model of pollution has been disclosed that allows a dispersion of pollutants to be computed for a given input topology and heterogeneous weather data. The computation is carried out using an LS-RBF-FD approach. The solution to the steady-state problem of Equation 1 is computed efficiently by a least-squares solver.

### Inverse Modeling, an Adjoint Approach

The inverse problem consists in simultaneously estimating the source term s̅∈ [symbol] ^{N}^{ₓ} and the pollutant concentration ū∈ [symbol] ^{N}^{ₓ} when a limited number of measurements is available. y̅ₘₑₛ∈ [symbol] ^{N}^{ₛ} with Nₛ the number of measurements located in Ω°. If a source term s̅ is known in X it is possible to estimate the source at any point z∈Y_{Ω°} using the interpolation formula of Equation 16 evaluated with neutral differential operators (without applying derivatives). Thus it is possible to construct an interpolation operator Ψₛ that makes it possible to approximate in X a source defined in Y_{Ω°}, such that s̅(Y_{Ω°})=Ψₛs̅.

The measurement operator denoted C is similarly defined as an operator of interpolation from the field space X to the measurement space, such that

[Eq. 22] y̅=Cū, with ū the model output, and y̅ the model output in the space of the localized measurements in Ω°.

For the purpose of estimating the source term, the following least-squares problem is solved—it is a question of the regularized minimization of the least-squares error between the output of the LS-RBF-FD model and the measurements—

$${min}_{\overline{s} , \overline{u}} 𝒥 ( \overline{s} , \overline{u} ) = \frac{1}{2} {‖ C \overline{u} - {\overline{y}}_{mes} ‖}_{{R}^{- 1}}^{2} + \frac{1}{2} {‖ \overline{s} ‖}_{{B}^{- 1}}^{2} \qquad [ Eq . 23 ]$$

$$under E \overline{u} - {D}_{Ω°}^{T} {Ψ}_{s} \overline{s} = 0 ,$$

where R and B are measurement-error and regularization covariance matrices, respectively.

The optimal solution (s̅*, ū*) to this problem of estimating the source term is the solution of the linear system,

$$( \begin{matrix}K & E \\ E & - Q\end{matrix} ) ( \begin{matrix}\overline{u} \\ \overline{λ}\end{matrix} ) = ( \begin{matrix}{C}^{T} {R}^{- 1} {\overline{y}}_{mes} \\ \overline{0}\end{matrix} ) , \qquad [ Eq . 24 ]$$

where K=C^{T}R⁻¹C, Q=D_{Ω°}^{T}ΨₛBΨₛ^{T}D_{Ω°}. In addition, s̅*=BΨₛ^{T}D_{Ω°}λ̅*, where λ̅* is the adjoint of ū*. Considering the matrix E to be positive definite, ū*=[E+QE⁻¹K]⁻¹QE⁻¹C^{T}R⁻¹y̅ₘₑₛ and λ̅* is given by λ*=−E⁻¹C^{T}R⁻¹(Cū*−y̅ₘₑₛ).

To provide confirmation of this, the Lagrangian of Equation 23,

$$L ( \overline{s} , \overline{u} , \overline{λ} ) = \frac{1}{2} {‖ C \overline{u} - {\overline{y}}_{mes} ‖}_{{R}^{- 1}}^{2} + \frac{1}{2} {‖ \overline{s} ‖}_{{B}^{- 1}}^{2} + {λ}^{T} ( E \overline{u} - {D}_{Ω°}^{T} {Ψ}_{s} \overline{s} )$$

is introduced. Lagrangian theory makes it possible to deduce the necessary conditions of optimality with:

$${∇}_{\overline{u}} L = 0 ⇔ {C}^{T} {R}^{- 1} ( C \overline{u} - {\overline{y}}_{mes} ) + E \overline{λ} = 0 \qquad [ Eq . 25 ]$$

$${∇}_{\overline{s}} L = 0 ⇔ {B}^{- 1} \overline{s} - {Ψ}_{s}^{T} {D}_{Ω°} \overline{λ} = 0 , \qquad [ Eq . 26 ]$$

$${∇}_{\overline{λ}} L = 0 ⇔ E \overline{u} - {D}_{Ω°}^{T} {Ψ}_{s} B \overline{s} = 0 , \qquad [ Eq . 27 ]$$

where Equation 25 is the adjoint equation of the model. If E is positive definite, and thus invertible, λ̅* may be explicitly computed as λ̅*=−E⁻¹C^{T}R⁻¹(Cū*−y̅ₘₑₛ). From Equation 26, s̅*=BΨₛ^{T}D_{Ω°}λ̅* is obtained.

Furthermore, by introducing the expression for s̅* into Equation 27, Eū*−Qλ̅*=0 is obtained. Finally, ū*=[E+QE⁻¹K]⁻¹QE⁻¹C^{T}R⁻¹y̅ₘₑₛ is obtained by introducing the expression for λ̅*. E+QE⁻¹K is always invertible if E is positive definite because the symmetric matrix QE⁻¹K is at least positive semi-definite.

The invertibility of the matrix E is guaranteed if and only if the differentiation matrix D in Equation 18 is of full rank. This condition may be met by choosing a suitable cardinality for X and Y. The linear system of Equation 24 of 2Nₓ×2Nₓ size is solved without explicit matrix inversion to speed up the computations for large domains, in particular through use of a LSQR least-squares solver.

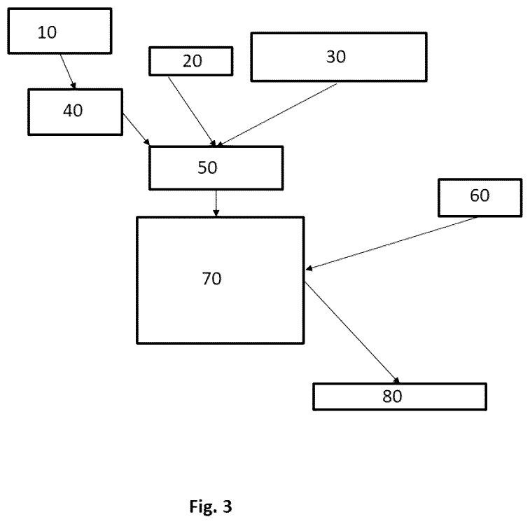

FIG. 3 Thus, the principle of the invention has been shown in FIG. 3. The data processor receives geometric information 10, a model 20 based on continuous partial differential equations (also referred to as the PDE model), and input field data 30—which are given for the interior of the domain.

In the main embodiment, these input field data are weather data, but in an embodiment pertaining to diffusion of heat through a material, they may be density in the material, electrical charge, or even salinity.

The geometric information 10, the model 20 based on continuous partial differential equations, and the input field data 30 are raw input data of the model.

The geometric information 10 is processed to obtain the boundary conditions of the domain, in a step 40. Processed input data are thus obtained, by creating a computational domain including the boundary conditions.

In a step 50, a discretization of the PDE model 20 is performed, with a view to discretizing it by means of LS-RBF-FD radial basis functions. This is done taking into account both the computational domain established in step 40, and the input field data 30. Discretized physical operators are obtained.

The method naturally comprises obtaining measurements 60.

Next, on the basis of the measurements 60 and of the discretized physical operators obtained in step 40, the inverse model 70 is implemented, this including iterative solution based on explicitation, in the processor and associated memory, of the adjoint equation of the discretized operators by matrix inversion, the radial basis functions having been chosen in order to make this inversion possible. The inverse model thus comprises solving a least-squares problem for the purposes of the iterative solution: a value representative of an error between the estimations made by the model and the measurements is minimized.

At the end of the inverse model 70, the coordinates—i.e. the positions—of the sources (or of the source, in the case of a single source) and optionally estimated emission rates are obtained. The intensities (often concentrations) at the various points of the domain are also optionally obtained. These are the results 80.

### Example of Implementation

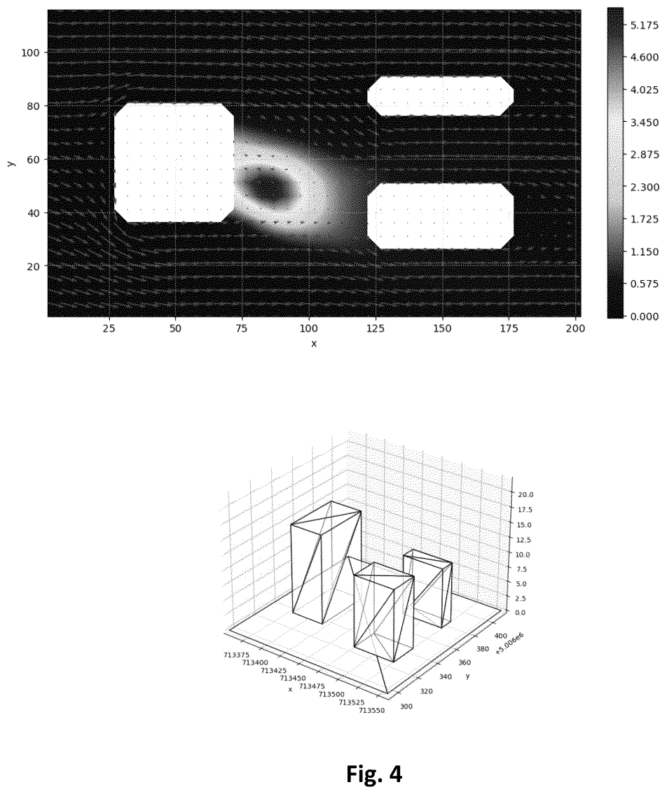

FIG. 4 The three-dimensional physical domain consisted of a domain containing three buildings with a height of 10, 15 and 12 meters, respectively. The dimensions of the domain were Lₓ=205 m×L_{y}=120 m×L_{z}=105 m. The three-dimensional domain has been shown in the right-hand part of FIG. 4. FIG. 2, which was mentioned above, shows the distribution of the evaluation nodes Y.

PHS5 radial basis functions were used, according to the equation

$$Φ ( y ) = {r}^{5} , with r = ‖ y - {x}_{i} ‖ . \qquad [ Eq . 28 ]$$

Regularization polynomials of order 2 were used. The direct LS-RBF-FD model of Equation 21 was used with 15000 evaluation nodes to ensure a good resolution. The set X contained many fewer nodes with Nₓ=2060, this naturally leading to a model reduction allowing the size of the vectors of unknowns s̅ and ū to be limited. No-flux Neumann boundary conditions were assigned to the ground, to the edges of the buildings and to the ceiling of the simulation domain, whereas Dirichlet conditions were imposed on the other edges of the domain. The stencil size was 90, the maximum order of regularization of the polynomials in Equation 7 being 2. The matrices R and B were chosen to be diagonal matrices with R=rI_{N}_{ₛ} and B=bI_{N}_{ₓ}, where I_{N.} designates an identity matrix of N.×N. size and where r and b are diagonal regularization coefficients. In the examples presented, r=1, b=0.15.

FIG. 4 shows, in the left-hand part, the pollutant concentration field (hue) and the wind field (arrows) at a height of 2 m above the ground. In the right-hand part, the studied domain, which contains three buildings of different sizes, has been shown. The source was located at a height of about two meters.

Weather data was used as input information for the computations. The mean wind fields were generated using the software package Parallel-Micro-SWIFT-SPRAY (PMSS), its Eulerian quasi-steady state wind-field model Micro-SWIFT-M, which solves Reynolds-averaged Navier-Stokes equations, being used to compute therefrom a mean wind field U and a diffusion K that expresses turbulent wind fluctuations that may be likened, over long time scales, to a diffusive effect. Weather data computed by models other than Micro-SWIFT-M could in principle be suitable for the LS-RBF-FD model presented above.

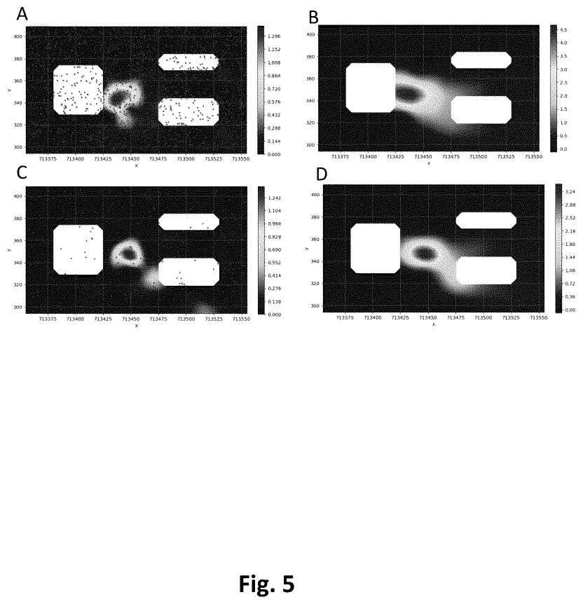

The measurements y̅ₘₑₛ were simulated by the LS-RBF-FD “forward” model in a fine computational domain with addition of noise, such that

[Eq. 29] y̅ₘₑₛ=y̅⁰+ϵ̅^{obs} with, ϵ̅^{obs}˜ [symbol] (0, σ²) where y̅⁰ is the reference pollutant concentration returned by a fine LS-RBF-FD model with N_{y}=50000, Nₓ=15648 (see the left-hand part of FIG. 3) and ϵ̅^{obs} a Gaussian noise of variance σ², with σ=0.002. The true source term used to generate the reference concentration field was a Gaussian defined in Ω°:

[Eq. 30] s: x [symbol] aₛ exp((x−xₛ)/(\sqrt{2}σₛ))², x∈Ω° with aₛ, xₛ, σₛ=1, [0.42Lₓ, 0.39L_{y}, 0.02L_{z}] and [8 m, 8 m, 8 m]. A 2D cross section of the source term is shown in FIG. 5.

Two inversion experiments were carried out with additive noise using 1500 and 200 measurements distributed throughout the three-dimensional computational domain.

FIG. 5 The estimated source terms, and the resulting concentration fields, are shown in FIG. 5. The source positions \hat{x}ₛ were well estimated in both cases, with errors less than 5 m in the x-y plane in the case of 1500 measurements (part A of the figure), \hat{x}ₛ having moved 25 m along x and 10 m along y in part C of the figure. Some inversion artifacts are visible in part C, where the source reaches 0.5 units instead of 0 near the building located to the south-east. However, the sources were estimated well enough to reconstruct, in parts B and D, pollution-field patterns closely resembling the reference field returned by the fine model shown in FIG. 2.

However, the field resulting from an estimation of the source term based on 1500 measurements (part B of FIG. 5) is a better order-of-magnitude field reconstruction than the one based on 200 measurements (part D of FIG. 5) because more information is provided.

A number of parameters may have an impact on the quality of an estimation of the source term. Among them, the number of nodes in X and Y and the weight of the regularization in the ratio b/r have an impact on the estimated pattern of the source and its order of magnitude.

The computation time is reasonably short. Once the operator matrix D had been computed, the estimation of the source and of its resulting field were obtained in about 4 minutes in this example with an Intel Xeon E-2276M 6-core processor and 32 Gb of RAM executing a still poorly optimized Python program.

In FIG. 5, a source estimation with 1500 measurements has been shown in quadrant A, a resulting concentration field has been shown in quadrant B, a source estimation with 200 measurements has been shown in quadrant C, and a concentration field reconstructed based on 200 measurements has been shown in quadrant D. The crosses correspond to the planar coordinates of the measurements. The results are displayed for a height of z=2 m.

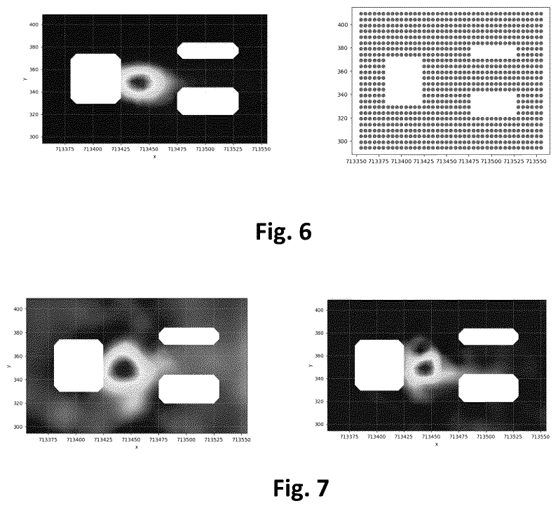

FIG. 6 The software package PMSS is able to qualitatively compute pollutant dispersion. Using the data returned by the PMSS particle model, in which the plume is generated by a point source (i.e. generated in a single mesh cell) and with many PMSS model particles, a quality reference field y̅₀ may be created (left-hand part of FIG. 6) and used to create a set of simulated measurements: here measurements all located in a domain plane at a height of 2.14 m (right-hand part of FIG. 6). It is then possible to determine the source with an LS-RBF-FD estimation model that is even further reduced (to 626 points) in X, and to obtain a correct estimation of the source and of its location in about thirty seconds.

Thus, in the left-hand part of FIG. 6, the reference PMSS field used to create the simulated measurements has been shown, the cross section illustrated being at a height of 2.14 m. In the right-hand part, the position of the measurements simulated by PMSS has been shown: a complete cross section of the PMSS domain at a height of 2.14 meters is shown, 860 measurements having been provided.

FIG. 7 Source estimation results with Nₓ=626 and 1865 points may be seen in FIG. 7 and show that the source position is very accurately estimated, even with an LS-RBF-FD inversion model that is very reduced, to 626 points in X (left-hand part of FIG. 7). However, using a finer LS-RBF-FD approximation model in X (Nₓ=1865) prevents the presence of source artifacts (as for example in the right-hand part of FIG. 7).

Thus, the left-hand part of FIG. 7 shows an adjoint source estimation with an LS-RBF-FD inversion model that is very reduced: Nₓ=626 points. The right-hand part shows an adjoint source estimation with a LS-RBF-FD inversion model reduced to Nₓ=626 points.

The adjoint method based on RBF-FD models therefore works with noisy measurements, obtained from a very fine LS-RBF-FD model, and produces estimations of source terms using 2060 unknowns when provided with 1500 or 200 measurements scattered over the domain.

In the case where the simulated measurements are provided by PMSS, i.e. a model different from the LS-RBF-FD model that was professionally developed and that has been validated in a wind tunnel (Moussafir et al., 2004), and where the measurements are located at an altitude of about 2 meters, the source is located very rapidly and very accurately with the inverse method presented above.

### Other Embodiments

The inversion procedure may incorporate Kalman filtering, which then allows the estimation to be updated by adding measurements without having to repeat a least-squares computation on a whole batch of measurements. An ensemble Kalman filter may be used and makes it possible not to have to explicitly compute inverses. This is particularly useful when the transient regime is of interest. Ensemble Kalman filters are suitable for problems of large dimensions.

According to yet another variant, an iterative adjoint procedure is carried out: this makes it possible to iterate toward the solution without having to store dense matrices in memory, and is therefore suitable for large domains.

According to yet another variant, a computationally efficient implicit time advancement scheme employing a physical solver is used to make the concentration states vary over time:

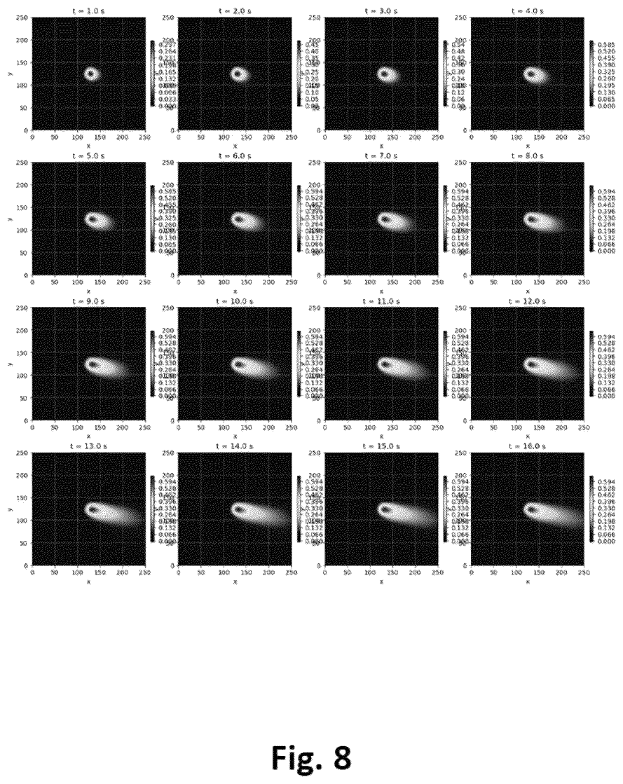

FIG. 8 shows in this context one example of a non-steady-state LS-RBF-FD variation.

The transient physical solver lays the foundation for the prospect of transient identification. It is formulated as follows: the non-steady-state problem creates a minimization problem similar to the steady-state problem where the computed solution, ūₐ it will be recalled, satisfies the minimization problem,

$${min}_{\overline{u}} ‖ D \overline{u} - \overline{f} ‖ \qquad [ Eq . 31 ]$$

In the non-steady-state problem, the variation as a function of time in the field variable u is added to the minimization constraint.

$${min}_{\overline{u}} ‖ {\partial }_{t} \overline{u} + D \overline{u} - \overline{f} ‖ \qquad [ Eq . 32 ]$$

To advance in time in a discrete computation scheme, a discrete derivative is expressed at a following time t+1 via an implicit scheme, the non-steady-state problem being expressed as

$${min}_{\overline{u} ( t + 1 )} ‖ {D}_{0} \frac{\overline{u} ( t + 1 ) - \overline{u} ( t )}{dt} + D \overline{u} ( t + 1 ) - \overline{f} ‖ \qquad [ Eq . 33 ]$$

with D₀ an RBF-FD operator with the derivative order 0 (interpolator) of Y_{Ω°} in X when it acts on nodes yₖ∈Y_{Ω°} and 0 otherwise. Hence,

$${D}_{0} ( {y}_{k} ) = \{ \begin{matrix}{\overline{w}}^{0} & ( {y}_{k} , X ) if {y}_{k} ∈ {Y}_{Ω°} \\ \overline{0} & otherwise\end{matrix} \qquad [ Eq . 34 ]$$

where w̅⁰ (yₖ, X) is a set of RBF-FD weights for performing a local interpolation of ū for a stencil centered on yₖ with n−1 neighbors in X.

Thus,

$${min}_{\overline{u} ( t + 1 )} ‖ \frac{{D}_{0}}{dt} [ \overline{u} ( t + 1 ) - \overline{u} ( t ) ] + D \overline{u} ( t + 1 ) - \overline{f} ‖ \qquad [ Eq . 35 ]$$

is solved, with

$$\{ \begin{matrix}{D}_{k} = {L}_{k} , & {y}_{k} ∈ {Y}_{Ω°} \\ {D}_{k} = {B}_{k} , & {y}_{k} ∈ {Y}_{\partial Ω}\end{matrix} \qquad [ Eq . 36 ]$$

Therefore, the following is solved

$${min}_{\overline{u} ( t + 1 )} ‖ ( \frac{{D}_{0}}{dt} + D ) \overline{u} ( t + 1 ) - ( \frac{{D}_{0}}{dt} \overline{u} ( t ) + \overline{f} ) ‖ \qquad [ Eq . 37 ]$$

This expression is solvable with LSQR or L-BFGS-B, conjugate gradients or other solvers.

Inverse modeling based on LS-RBF-FD is applicable to any search for unknowns, source terms or even field variables in partial differential equations. Thus, it may be employed to identify (locate) hot spots in batteries, or to estimate a source in a CBRN-E context (for example biological/chemical contamination in a water network, an induced leak, etc.).

In the case of pollution, the method is a useful way of identifying sources of pollution for high-risk services (firefighters, army, etc.).

The invention may also be used to locate acoustic sources in complex environments.

### LIST OF CITED REFERENCES

Barnett, G.A., 2015. A Robust RBF-FD Formulation based on Polyharmonic Splines and Polynomials. University of Colorado Boulder.
Defforge, C., 2019. Data assimilation for micrometeorological applications with the fluid dynamics model Code_Saturne. Paris-Est, Paris.
Flyer, N., Lehto, E., Blaise, S., Wright, G.B., St-Cyr, A., 2012. A guide to RBF-generated finite differences for nonlinear transport: Shallow water simulations on a sphere. J. Comput. Phys. 231, 4078-4095. https://doi.org/10.1016/j.jcp.2012.01.028
Fornberg, B., Flyer, N., 2015. A Primer on Radial Basis Functions with Applications to the Geosciences, Society for Industrial and Applied Mathematics. ed.
Khodayi-mehr, R., 2019. Model-Based Learning and Control of Advection-Diffusion Transport Using Mobile Robots 285.
Kumar, P., Feiz, A.-A., Singh, S.K., Ngae, P., Turbelin, G., 2015. Reconstruction of an atmospheric tracer source in an urban-like environment. J. Geophys. Res. Atmospheres 120, 12589-12604. https://doi.org/10.1002/2015JD024110
Liu, J., Li, X., Hu, X., 2019. A RBF-based differential quadrature method for solving two-dimensional variable-order time fractional advection-diffusion equation. J. Comput. Phys. 384, 222-238. https://doi.org/10.1016/j.jcp.2018.12.043
Mons, V., Margheri, L., Chassaing, J.-C., Sagaut, P., 2017. Data assimilation-based reconstruction of urban pollutant release characteristics. J. Wind Eng. Ind. Aerodyn. 169, 232-250. https://doi.org/10.1016/j.jweia.2017.07.007
Moussafir, J., Oldrini, O., Tinarelli, G., Sontowski, J., 2004. A new operational approach to deal with dispersion around obstacles: the MSS (Micro Swift Spray) software suite. 5.
Septier, F., Armand, P., Duchenne, C., 2020. A bayesian inference procedure based on inverse dispersion modelling for source term estimation in built-up environments. Atmos. Environ. 242, 117733. https://doi.org/10.1016/j.atmosenv.2020.117733
Tominec, I., Larsson, E., Heryudono, A., 2021. A least squares radial basis function finite difference method with improved stability properties (No. arXiv:2003.03132). arXiv.

1. A method for determining spatial coordinates of a source causing a dispersion effect in a domain, the dispersion effect being approximated by a system of partial differential equations, the method comprising computer-implemented steps,
of obtaining measurements each quantifying at a point in space in the domain and at a given time a state variable modeled by the system of partial differential equations at said point and at said time, and
of iteratively minimizing differences between the measurements and the computations of the system of equations to locate a position of said source, the method wherein the system of equations is expressed in terms of finite differences generated by radial basis functions, the system of equations being solved in a least-squares context, using a least-squares solver, the system of equations having been subject to adjoint quadratic solution with radial basis functions chosen from polyharmonic-spline functions, inverse-multiquadric functions, or Gaussian functions.

2. The method for determining coordinates according to claim 1, wherein the steps of obtaining the localized measurements and of minimizing the differences between the measurements and computations are carried out in a spatial domain described with Neumann and Dirichlet boundary conditions.

3. The method for determining coordinates according to claim 1, wherein the domain is characterized, in addition to its boundaries, also by field data in the interior of the domain.

4. The determining method according to claim 1, wherein the dispersion effect is a dispersion of pollutants and that said transport is modeled by an advection-diffusion equation.

5. The determining method according to claim 1, wherein the dispersion effect is diffusion of heat from a hot spot in an energy system.

6. The determining method according to claim 1, wherein the dispersion effect is sound spreading in a complex environment.

7. The determining method according to claim 1, wherein the least-squares solver is of L-BFGS-B or LSQR type.

8. The determining method according to claim 1, wherein the radial basis functions are PHS5 polyharmonic-spline functions.

9. The determining method according to claim 1, wherein the iterative minimization of the differences between the measurements and the computations of the system of equations is carried out in order also to determine an intensity of said source.
